(19) United States
(12) Patent Application Publication
(10) Pub. No.: US 2021/0291919 A1
(43) Pub. Date: Sep. 23, 2021

(54) Lighting System for a Bicycle

(71) Applicant: They, Galveston, TX (US)

(72) Inventor: They, Galveston, TX (US)

(21) Appl. No.: 16/823,622

(22) Filed: Mar. 19, 2020

(51) Int. Cl. B62J 6/015; F21V 23/02; F21S 9/02; F21V 23/04; F21V 23/06; F21V 23/00; B62J 6/26; B62J 6/045; B62J 6/055

(52) U.S. Cl. CPC B62J 6/015; F21V 23/023; F21S 9/02; F21V 23/04; F21Y 2115/10; F21V 23/003; B62J 6/26; B62J 6/045; B62J 6/055; F21V 23/06

(57) ABSTRACT

Provided herein is a lighting system for a two- or three-wheeled vehicle. The lightning system has at least one light bar each of which has a housing enclosing a support matrix to which a plurality of light emitting diodes are operably attached, a power supply and at least one mount to secure the light bar to the two- or three-wheeled vehicle. The power supply is operably connected to the light bar to operate the light emitting diodes. The power supply may have a driver for operating the light emitting diodes in a sequence.

### BACKGROUND OF THE INVENTION

### Field of the Invention

The invention relates to the field of accessories for pedaled vehicles. More specifically, the present invention is directed to a lighting system for use on pedaled vehicles with two- or three wheels.

### Description of the Related Art

Bicycling is a popular leisure activity and is also used as a means of transportation around the world. A 2016 survey showed that around 12.4 percent of Americans cycled on a regular basis, with the numbers increasing over the past three years from around 43 million to 47.5 million. While being an inexpensive alternative to conventional transportation, cyclists are frequently at risk for injury and death from accidents. A 2015 CDC report revealed that over 1,000 bicyclists died and almost 467,000 individuals sustained bicycle-related injuries. Data from 2010 show fatal and non-fatal crash-related injuries to bicyclists resulted in lifetime medical costs and productivity losses of $10 billion. Much of the fatalities to bikers occurs in the dark and in areas that are poorly lighted. Such accidents may be easily avoided by equipping the bicycle with proper lighting, which enables clear view of the biking path, and also alerts motorists and other bikers. Conventional bicycle lighting include headlights and taillights that are powered by a battery or a dynamo. Many of these lights consume a lot of power requiring frequent replacement of batteries. Moreover, dynamos work only when the rider is cycling and does not provide illumination when the bike is stationary or moving at low speeds.

There is a need in the art for improved, long lasting lighting solutions for the safety of bikers. The present invention fulfills this longstanding need and desire in the art.

### SUMMARY OF THE INVENTION

The present invention is directed to a lighting system for a two- or three-wheeled vehicle. The lighting system comprises at least one light bar where each comprise a plurality of light emitting diodes, a support matrix comprising the plurality of light emitting diodes operably attached thereto and a first housing with a first end, a second end, a front surface, and a back surface enclosing the support matrix therein. At least one power supply is operably connected to the light bar and a second housing encloses the power supply therein. At least one mount is disposed on the light bar for removable attachment of the lighting system to the two- or three-wheeled vehicle.

The present invention also is directed to a lighting system for a bicycle. The lighting system comprises a first housing having a first end, a second end, a transparent front surface, and an opaque back surface and, housed therein, a support matrix with a plurality of light emitting diodes operably attached thereto. The first housing, support matrix and plurality of light emitting diodes comprise a light bar where the light bar has at least one mount disposed thereon to removably secure the light bar to the bicycle. A second housing has a first side and a second side and a pair of openings formed coaxially through the first side and the second side and, housed therein, a power supply operably connected to the light bar. The pair of openings have an inner dimension across a surface thereof greater than an outer dimension of the light bar where the light bar is received through the pair of openings.

Other and further aspects, features, and advantages of the present invention will be apparent from the following description of the presently preferred embodiments of the invention given for the purpose of disclosure.

### BRIEF DESCRIPTION OF THE DRAWINGS

So that the matter in which the above-recited features, advantages and objects of the invention, as well as others that will become clear, are attained and can be understood in detail, more particular descriptions of the invention briefly summarized above may be had by reference to certain embodiments thereof that are illustrated in the appended drawings. These drawings form a part of the specification. It is to be noted, however, that the appended drawings illustrate preferred embodiments of the invention and therefore are not to be considered limiting in their scope.

FIGS. 1A-1C show a lighting system. FIG. 1A is a front view of the lighting system. FIG. 1B is a front view of the lighting system shown in FIG. 1A with the power supply in cross-section. FIG. 1C is a top view of the lighting system.

FIG. 2 is a cartoon of a bicycle showing the lighting system attached to the stem thereof.

FIG. 3 is a cartoon of a bicycle showing the light bar attached at the front and at the back of a bicycle.

FIG. 4 is a cartoon of a bicycle showing the two light bars as in FIG. 3 connected to the same power supply. The handlebars are not oriented with respect to the light bar to better show the connection to the power supply.

### DETAILED DESCRIPTION OF THE PRESENT INVENTION

For convenience, before further description of the present invention, certain terms employed in the specification, examples and appended claims are collected herein. These definitions should be read in light of the remainder of the disclosure and understood as by a person of skill in the art. Unless defined otherwise, all technical and scientific terms used herein have the same meaning as commonly understood by a person of ordinary skill in the art.

The articles “a” and “an” when used in conjunction with the term “comprising” in the claims and/or the specification, may refer to “one”, but it is also consistent with the meaning of “one or more”, “at least one”, and “one or more than one”. Some embodiments of the invention may consist of or consist essentially of one or more elements, components, method steps, and/or methods of the invention. It is contemplated that any composition, component or method described herein can be implemented with respect to any other composition, component or method described herein.

The term “or” in the claims refers to “and/or” unless explicitly indicated to refer to alternatives only or the alternatives are mutually exclusive, although the disclosure supports a definition that refers to only alternatives and “and/or”.

The terms “comprise” and “comprising” are used in the inclusive, open sense, meaning that additional elements may be included.

The term “including” is used herein to mean “including, but not limited to”. “Including” and “including but not limited to” are used interchangeably.

As used herein, the terms “proximal” and “distal” in reference to the two- or three-wheeled vehicle, for example, but not limited to, a bicycle, disclosed herein refer to those components, features, parts and aspects thereof that are nearer or nearest to or farther or farthest from the front wheel of the vehicle, respectively.

As used herein, the terms “front” and “back” in reference to the first housing and the second housing disclosed herein refer to the part, portion or surfaces thereof that face outwardly from or inwardly toward a rider on the two- or three-wheeled vehicle, respectively,

As used herein, the term support matrix refers to a material, rigid or flexible, to which the plurality of light emitting diodes are operably attached and which material is operably directly or indirectly attached to the power supply.

In one embodiment of the present invention there is provided a lighting system for a two- or three-wheeled vehicle comprising at least one light bar, each comprising a plurality of light emitting diodes; a support matrix comprising the plurality of light emitting diodes operably attached thereto; and a first housing with a first end, a second end, a front surface, and a back surface enclosing the support matrix therein; at least one power supply operably connected to the light bar; a second housing enclosing the power supply therein; and at least one mount disposed on the light bar for removable attachment of the lighting system to the two- or three-wheeled vehicle.

In this embodiment the front surface of the first housing may comprise a transparent material. Also in this embodiment the back surface of the first housing may comprise an opaque material. In addition the second housing comprises a pair of openings formed coaxially through a first side thereof and through a second side thereof, each of the pair of openings having an inner dimension across a surface thereof greater than an outer dimension of the first housing, where the light bar is received through the pair of openings.

In this embodiment the power supply may comprise a battery receptacle; at least one battery operably disposed within the battery receptacle; and an on-off switch operably connected between the battery receptacle and the light bar. In an aspect of this embodiment, the battery may be rechargeable. Further to this aspect, the power supply comprises a charging port disposed on a front surface of the second housing; and a charging controller disposed within the second housing and operably connected between the charging port and the battery receptacle.

Further to these embodiments and aspects thereof the power supply comprises a programmable light emitting diode driver operably connected between the power supply and the light bar. In this further embodiment and aspects thereof the programmable light emitting diode driver is configured to operate the plurality of light emitting diodes in a sequence. Particularly the sequence may comprise a braking sequence, a blinking sequence, a left turn sequence, or a right turn sequence.

In this embodiment each light bar may be individually and operably connected to one of the at least one power supply. Alternatively, each light bar may be operably connected to one power supply. Also in this embodiment the light bar may be removably attached a proximal end of the two- or three-wheeled vehicle, may be removably attached to a distal end of the two- or three-wheeled vehicle or may be a combination thereof. In addition in this embodiment and aspects thereof, the light bar may have a length equal to or less than a length between handlebar grip ends on the two- or three-wheeled vehicle. Also in this embodiment and aspects thereof the two- or three-wheeled vehicle is a bicycle, a tricycle, a motorized bicycle, or a motorized tricycle.

In another embodiment of the present invention there is provided a lighting system for a bicycle, comprising a first housing having a first end, a second end, a transparent front surface, and an opaque back surface and, housed therein, a support matrix with a plurality of light emitting diodes operably attached thereto, said first housing, said support matrix and said plurality of light emitting diodes comprising a light bar, said light bar having at least one mount disposed thereon to removably secure the light bar to the bicycle; and a second housing comprising a first side and a second side and a pair of openings formed coaxially through the first side and the second side and, housed therein, a power supply operably connected to the light bar, said pair of openings having an inner dimension across a surface thereof greater than an outer dimension of the light bar, said light bar received through the pair of openings.

In this embodiment the power supply may comprise a battery receptacle; at least one battery operably disposed within the battery receptacle; an on-off switch operably connected between the battery receptacle and the light bar. Further to this embodiment the power supply comprises a programmable light emitting diode driver operably connected between the power supply and the light bar and configured to operate the plurality of light emitting diodes in a braking sequence, in a blinking sequence, in a left turn sequence, or in a right turn sequence. In an aspect of this embodiment the battery is rechargeable, where the power supply further comprises a charging port disposed on a front surface of the second housing; and a charging controller disposed within the second housing and operably connected between the charging port and the battery receptacle. In this embodiment and aspect thereof the light bar may be removably secured to a proximal end of the bicycle, may be removably secured to a distal end of the bicycle vehicle or may be a combination thereof.

Provided herein is a lighting system for a two- or three-wheeled vehicle, particularly a pedaled vehicle. For example, the vehicle may be a bicycle, a tricycle, such as a tricycle for an adult, a motorized bicycle, or a motorized tricycle as are known in the art. The lighting system has at least one light bar each of which generally is a support matrix to which a plurality of light emitting diodes are operably attached enclosed in a housing or first housing. A power supply is operably connected to the light bar, specifically to the support matrix, to operate the light emitting diodes.

The support matrix may be any material, rigid or flexible, that supports the attachment of the light emitting diodes thereto and that is operably attachable or connectable to the power source. For example, the support matrix may be a circuit board or a flexible ribbon matrix. The light emitting diodes may be attached to the support matrix by any means that enables operation thereof. For example, the light emitting diodes may be soldered, slotted or pinned to the support matrix or otherwise connected. The light emitting diodes are operably connected on the support matrix in series, in parallel circuit configuration. In another aspect a series circuit configuration is used. A series-parallel combination circuit also may be used.

The plurality of light emitting diodes and the support matrix are enclosed or housed in a first housing. The first housing may be made from a waterproof material to protect the circuit and components. The first housing has a front surface that is transparent to light and a back surface that is opaque to light. The front surface and the back surface of the first housing are independently made from any suitable material including, but not limited to, a polymer, a polycarbonate, a composite or a combination of these.

The plurality of light emitting diodes may be of a single color, an alternating color sequence, or may be multicolored. Also, the plurality of light emitting diodes may be arranged on the support matrix in any configuration including a linear and a non-linear configuration. The light emitting diodes may be attached on the support matrix in any arrangement including, equidistant from each other or randomly arranged. For example, the light emitting diodes may be arranged linearly on the support matrix to emit light in a forward direction and a single light emitting diode attached on each end of the support matrix to emit light laterally. In a non-limiting example, the light bar may have a length equal to or less than the distance between the grip ends of the handlebars on the two- or three-wheeled vehicle.

The power supply provides electrical power to the light bar. The power supply is enclosed or housed in a second housing and may include at least one battery operably disposed within a battery receptacle and an on-off switch operably connected between the battery receptacle and the light bar. The second housing may be made from any suitable material including, but not limited to, a polymer, a polycarbonate, a composite or a combination of these.

The battery may be a single-use battery or, alternatively, the battery is a rechargeable battery. If the battery is rechargeable, the power supply has a charging port disposed on a front surface of the second housing and a charging controller disposed within the second housing. One of ordinary skill in the art is well able to determine the number of batteries and battery size required to operate the light bar depending on the number and arrangement of light emitting diodes in the support matrix.

The charging controller is operably connected between the charging port and the battery receptacle. The charging controller enables charging the rechargeable battery to capacity and prevents overcharging, thereby avoiding damage to the lighting system. Any commercially available charging controller may be used.

The second housing enclosing the power supply may be provided with a pair of coaxial openings on a first side and on a second side. The coaxial openings have dimensions or diameters greater than the outer dimensions of the first housing or light bar. This enables the first housing comprising the light bar to be inserted through the pair of coaxial openings and, optionally, secured by a suitable securing means to the second housing. The second housing is secured directly to the vehicle using the mount. Alternatively, the light bar and the power supply may be independently secured to the vehicle using mounts. The mount is any removable means for mounting that secures the lighting system to the two- or three-wheeled vehicle, including, but not limited to screw mounts, cable ties, clamps and mounting rings or clips.

The lighting system may comprise a programmable light emitting diode driver disposed within the second housing. The light emitting diode driver is operably connected between the power supply and the light bar. The light emitting diode driver is pre-programmed for controlling various sequential operations of the light emitting diodes so that all or some of the light emitting diodes may be switched on. The light emitting diode driver is beneficial since it allows pre-programming lighting sequences including but not limited to a brake sequence, a hazard (blinking) sequence, a left turn sequence and a right turn sequence. A multi-function switch disposed on a front surface of the second housing enables powering the lighting system and switching between various lighting sequences.

Particularly, embodiments of the present invention are better illustrated with reference to the Figure(s), however, such reference is not meant to limit the present invention in any fashion. The embodiments and variations described in detail herein are to be interpreted by the appended claims and equivalents thereof.

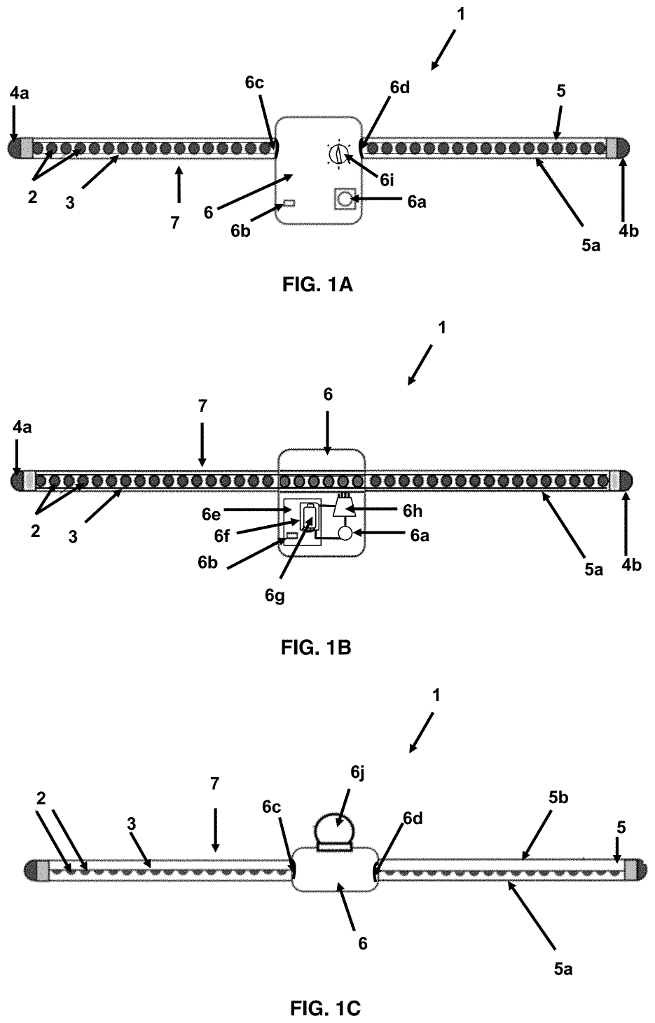

FIG. 1A is a front view of the lighting system 1 comprising a light bar 7 and a power supply 6 and a mount 6j (see FIG. 1C). The light bar has a support matrix 3 comprising the plurality of light emitting diodes as represented by 2 attached thereto. A pair of light emitting diodes 4a,b are operably connected to the support matrix to enable illumination in the lateral direction. A first housing 5 with a transparent front surface 5a encloses or houses the support matrix and light emitting diodes. A second housing 6 encloses or houses the power supply. An on-off switch 6a and a charging port 6b are disposed on the front surface of the second housing provides power to operate the light emitting diodes. A multi-function switch 6i enables selection of a desired lighting sequence. The first housing is received through coaxial openings 6c and 6d on a first side and a second side, respectively, of the second housing.

With continued reference to FIG. 1A, FIG. 1B is a front view of the lighting system with the second housing shown in cross-section. The second housing the charging controller 6e, battery receptacle 6f, rechargeable battery 6g and the light emitting diode driver 6h. The light emitting diode driver enables the user to switch between desired lighting sequences using the multi-function switch.

With continued reference to FIGS. 1A and 1B, FIG. 1C is a top view of the lighting system showing the support matrix 3 comprising the light emitting diodes 2, the first housing 5 with a transparent front surface 5a and an opaque back surface 5b housing the light emitting diodes and the support matrix. A mount 6j attached on a back surface of the second housing enables removable securing of the lighting system to the bicycle.

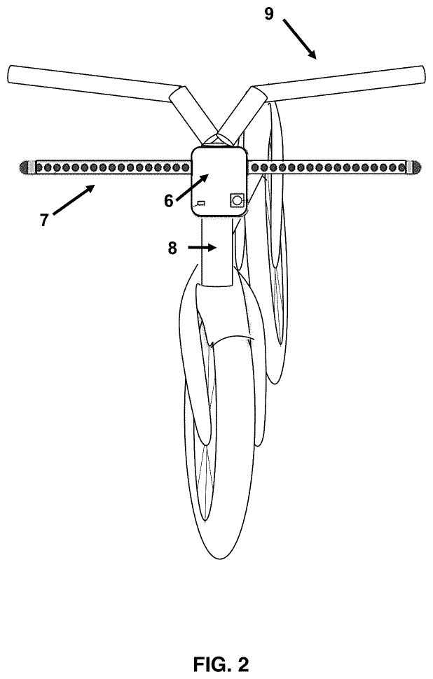

With continued reference to FIGS. 1A-1C, FIG. 2 shows the light bar 7 and power supply 6 of the lighting system attached to the stem 8 of a bicycle 9.

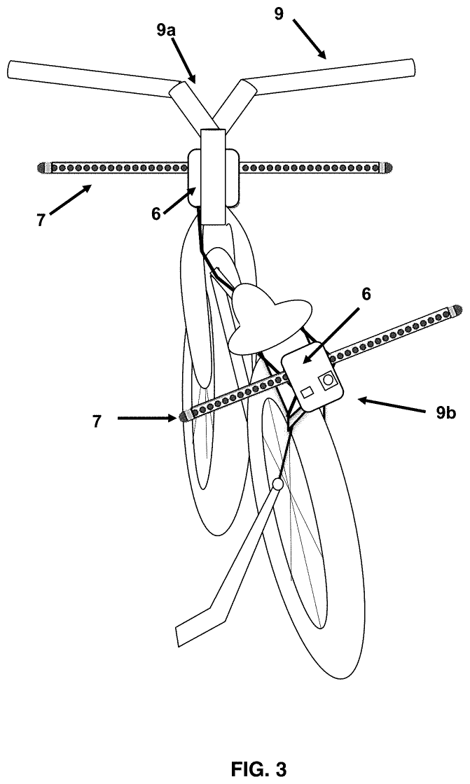

With continued reference to FIG. 2, FIG. 3 shows a lighting system comprising two light bars 7 each with a power supply 6. The light bars are attached to bicycle 9 at the proximal end 9a and at the distal end 9b.

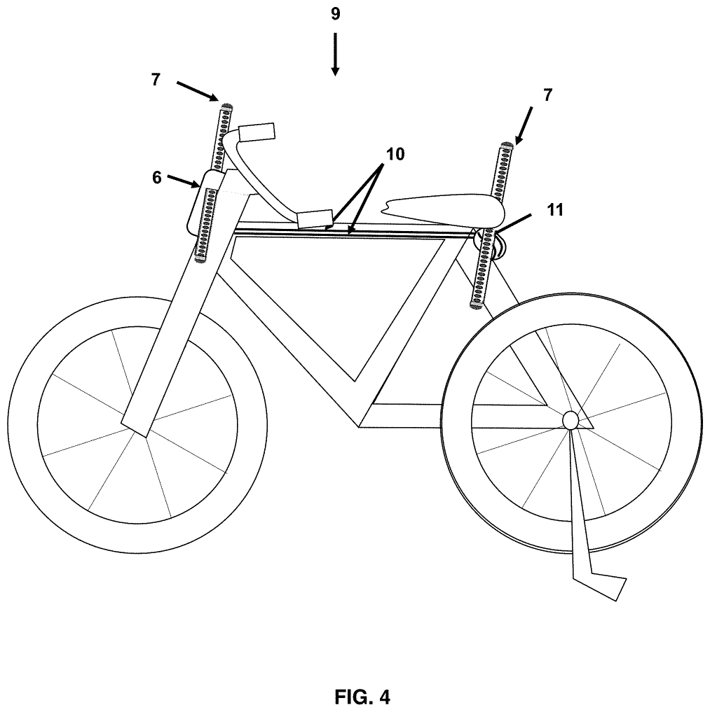

With continued reference to FIGS. 2 and 3, FIG. 4 is a side view of the bicycle 9 with the two light bars 7 attached at the proximal and distal ends thereof. A single power supply 6 provides power to the light bar at the proximal end of the bike and to the light bar at the distal end of the bike via electrical leads, wiring or cables 10. A mount or clamp 11 or other means for attachment enables securement of the light bar to the distal end of the bicycle.

1: A lighting system for a two- or three-wheeled vehicle, comprising:
at least one light bar, each comprising:
a plurality of light emitting diodes;
a support matrix comprising the plurality of light emitting diodes operably attached thereto; and
a first housing with a first end, a second end, a front surface, and a back surface enclosing the support matrix therein;
at least one power supply operably connected to the light bar;
a second housing enclosing the power supply therein and comprising a pair of openings formed coaxially through a first side thereof and through a second side thereof, each of said pair of openings having an inner dimension across a surface thereof greater than an outer dimension of the first housing, said light bar received through the pair of openings; and
at least one mount disposed on the light bar for removable attachment of the lighting system to the two- or three-wheeled vehicle.

2. (canceled)

3: The lighting system of claim 1, wherein the power supply comprises:
a battery receptacle;
at least one battery operably disposed within the battery receptacle; and
an on-off switch operably connected between the battery receptacle and the light bar.

4: The lighting system of claim 3, wherein the battery is rechargeable.

5: The lighting system of claim 4, wherein the power supply further comprises:
a charging port disposed on a front surface of the second housing; and
a charging controller disposed within the second housing and operably connected between the charging port and the battery receptacle.

6: The lighting system of claim 3, wherein the power supply further comprises a programmable light emitting diode driver operably connected between the power supply and the light bar.

7: The lighting system of claim 6, wherein the programmable light emitting diode driver is configured to operate the plurality of light emitting diodes in a sequence.

8: The lighting system of claim 7, wherein the sequence comprises a braking sequence, a blinking sequence, a left turn sequence, or a right turn sequence.

9: The lighting system of claim 1, wherein the front surface of the first housing comprises a transparent material.

10: The lighting system of claim 1, wherein the back surface of the first housing comprises an opaque material.

11: The lighting system of claim 1, wherein each light bar is individually and operably connected to one of the at least one power supply.

12: The lighting system of claim 1, wherein each light bar is operably connected to one power supply.

13: The lighting system of claim 1, wherein the light bar is removably attached a proximal end of the two- or three-wheeled vehicle, is removably attached to a distal end of the two- or three-wheeled vehicle or a combination thereof.

14: The lighting system of claim 1, wherein the light bar has a length equal to or less than a length between handlebar grip ends on the two- or three-wheeled vehicle.

15: The lighting system of claim 1, wherein the two- or three-wheeled vehicle is a bicycle, a tricycle, a motorized bicycle, or a motorized tricycle.

16: A lighting system for a bicycle, comprising:
a first housing having a first end, a second end, a transparent front surface, and an opaque back surface and, housed therein, a support matrix with a plurality of light emitting diodes operably attached thereto, said first housing, said support matrix and said plurality of light emitting diodes comprising a light bar, said light bar having at least one mount disposed thereon to removably secure the light bar to the bicycle; and
a second housing comprising a first side and a second side and a pair of openings formed coaxially through the first side and the second side and, housed therein, a power supply operably connected to the light bar, said pair of openings having an inner dimension across a surface thereof greater than an outer dimension of the light bar, said light bar received through the pair of openings.

17: The lighting system of claim 16, wherein the power supply comprises:
a battery receptacle;
at least one battery operably disposed within the battery receptacle;
an on-off switch operably connected between the battery receptacle and the light bar.

18: The lighting system of claim 17, wherein the power supply further comprises a programmable light emitting diode driver operably connected between the power supply and the light bar and configured to operate the plurality of light emitting diodes in a braking sequence, in a blinking sequence, in a left turn sequence, or in a right turn sequence.

19: The lighting system of claim 17, wherein the battery is rechargeable, said power supply further comprising:
a charging port disposed on a front surface of the second housing; and
a charging controller disposed within the second housing and operably connected between the charging port and the battery receptacle.

20: The lighting system of claim 16, wherein the light bar is removably secured to a proximal end of the bicycle, is removably secured to a distal end of the bicycle vehicle or a combination thereof.
